(19) United States
(12) Patent Application Publication
(10) Pub. No.: US 2012/0082530 A1
(43) Pub. Date: Apr. 5, 2012

(54) SYSTEM AND METHOD FOR SUBMERGING A HYDRAULIC TURBINE ENGINE

(75) Inventors: Jean-Luc Achard, Grenoble (FR); Thomas Jaquier, Grenoble (FR); Zanette Jeronimo, Grenoble (FR)

(73) Assignee: Electricite de France, Paris (FR)

(21) Appl. No.: 13/256,284

(22) PCT Filed: Mar. 12, 2010
(86) PCT No.: PCT/FR2010/050436

§ 371 Date: Nov. 21, 2011

(30) Foreign Application Priority Data
Mar. 13, 2009 (FR) 0951595

(51) Int. Cl. B63B 27/08; B65G 67/60

(52) U.S. Cl. 414/142.8; 414/803

(57) ABSTRACT

The instant disclosure relates to a system for submerging a hydraulic turbine engine, including an assembly including an elongate transverse flow turbine engine; a carriage for receiving said assembly in a prone position; a ship provided with a winch for supporting the carriage on the deck thereof, the bottom side of the turbine engine facing the stern of the ship, the top side being tied to the winch by a pull line; and jacks for righting the carriage and said assembly to a position that is vertically perpendicular to the stern.

### FIELD OF THE INVENTION

The present invention relates to a method and a system for submerging a hydraulic turbine engine down to a seabed.

### DISCUSSION OF PRIOR ART

Among clean natural energy sources, a currently underexploited energy source corresponds to water currents naturally present around the world: open sea currents, tidal currents, strait and estuary currents, stream or river currents.

Installation methods and systems are a key point for the industrial success of hydraulic turbine engines. They must first enable to safely install hydraulic turbine engines on sites that may reach great depths (down to 200 meters). Second, limiting the machine installation cost is essential. Now, in many currently-used systems, this cost may largely exceed machine manufacturing costs.

Thus, it has been provided to use permanent floating platforms, drilled or anchored, originating from off-shore oil drilling.

It has also been provided to attach the turbines to piles. The drilling or piling operations necessary to install the piles are hazardous and technically long, difficult, and expensive since they are the transposition of complex operations used for offshore oil drilling. Further, the ground of the site where a pile is to be installed (sands, clays) must have good geomechanical features, especially for the drilling.

Gravity-type solutions where the water turbine is attached to a heavy body, for example, a strengthened concrete block or plate, which is placed on the sea or river bed, have also been provided. The ground of the location where these bodies are deposited (sands, clays) must be modified before the installation to make it possible. Further, such foundations are heavy and bulky. Their installation requires extremely powerful cranes, which are embarked on support vessels. Lastly, operations are risky on high seas if the vessel does not itself have considerable dimensions to remain steady in the swell during transshipment operations. Subsea Inspection, Maintenance, and Repair (IMR) support vessels designed for offshore oil drilling are thus considered: MAERSK's “Subsea Support/Cable Laying Vessels”, JUMBO's “Heavy Lift Cargos”, DOCKWISE's “Open Deck Heavy Transport Carrier”. IMR vessels, which are generally provided with a dynamic positioning technology, equipped with cranes sometimes integrating swell compensation systems, and capable of handling loads of 100 tons down to 3,000 meters deep, also have a very large deck surface area. Such vessels further provide all lift and logistic support capacities. But they have a low availability and bring about very high operating costs (handling, transport).

Patent applications WO2008125285 and WO2008125286, provide using a specific self-propelled or towed multihulled floating platform (a catamaran, or possibly a trimaran), having at its center a portal of sufficient dimensions to let through a large axial flow turbine. The turbine base structure is secured under the platform. The installation comprises several steps: a pre-installation of the turbine+base assembly on the vessel, the vessel being alongside the quay of the port of departure, and a laying down of the above assembly on the sea or river bed, while the vessel is above the selected installation site, by means of pull lines (cables, ropes, chains moved by winches secured on the vessel). Thus solution has several disadvantages:
it requires a dedicated floating platform;
in the case where the platform is towed (less expensive option preferred by the authors), the maneuverability of the platform+tug assembly is low and makes it difficult to face harsh weather conditions during the travel from the port of departure to the selected site or from the port of departure to another portion of departure (this last operation requires, according to authors, the dismantling of the platform and its transportation in a cargo ship);
the pre-installation alongside the quay of the port of departure is not direct;
during the laying down, reaching given positioning parameters of the turbine engine+base assembly is either difficult (orientation of the turbine engine with respect to the current via a management of several pull lines fastened to the foundation), or impossible (the horizontality of the turbine engine cannot be provided if the bottom is not horizontal).

### FIELD OF THE INVENTION

An object of an embodiment of the present invention is to provide a method and a system for submerging a hydraulic turbine engine down to a sea or river bed, which enables to obtain a reasonable installation cost as compared with the actual machine manufacturing cost.

An object of an embodiment of the present invention is to provide a fast and safe installation, which does not require the presence of divers or of large crafts.

An object of an embodiment of the present invention is to provide an installation which can use current non-specific vessels.

An object of an embodiment of the present invention is to provide an installation which enables to install hydraulic turbine engines on sites as deep as 200 meters.

Generally, to achieve all or part of these and other objects, the present invention provides selecting as a turbine engine a cross-flow turbine engine of elongated shape. It will be shown that such cross-flow turbine engines are particularly well adapted to a simple assembly and submersion mode requiring no specific vessel.

More specifically, an embodiment of the present invention provides a method for submerging a hydraulic turbine engine, comprising the steps of:
providing an assembly comprising a cross-flow turbine engine of elongated shape;
laying down said assembly on a carriage;
arranging the carriage on the deck of a ship, the lower end of the turbine engine facing the stern of the ship, the upper end being attached by a pull line to a winch secured to the ship;
placing the carriage and said assembly in upright position above the stern of the ship;
separating said assembly from the carriage; and
lowering said assembly towards the bottom while holding it by means of said pull line.

According to an embodiment of the present invention, said assembly comprises a base structure solidly attached to the lower end of the turbine engine.

According to an embodiment of the present invention, during the step where the carriage is placed upright, the turbine engine is attached to the carriage by removable fasteners.

According to an embodiment of the present invention, the base structure comprises extendable arms, and the method further comprises, once the turbine engine has been lowered all the way down to the bottom, the steps of:
extending the arms; and
setting the heights of their support points on the bottom.

An embodiment of the present invention provides a system for submerging a hydraulic turbine engine comprising:
an assembly comprising a cross-flow turbine engine of elongated shape;
a carriage capable of receiving said assembly in lying position;
a ship provided with a winch capable of supporting the carriage on its deck, the lower side of the turbine engine facing the stern of the ship, the upper side being linked by a pull line to the winch; and
jacks for placing the carriage and said assembly in upright position above the stern.

According to an embodiment of the present invention, said assembly comprises a base structure solidly attached to the lower end of the turbine engine.

According to an embodiment of the present invention, the ship is provided with a dynamic positioning system, and transmit means are connected to the bottom of the turbine engine or to the base structure.

According to an embodiment of the present invention, the base structure comprises a base plate having extendable arms solidly attached thereto, each arm being associated with one or several jacks to extend and be set, the turbine engine being linked to the ship during its positioning by electric cables capable of driving the various jacks.

According to an embodiment of the present invention, the pull line is connected to the top of a structure for holding the turbine engine.

According to an embodiment of the present invention, the pull line is connected to the turbine engine via electromagnets.

According to an embodiment of the present invention, the base structure comprises a base plate on which is assembled a plate pivoting around a vertical axis, the turbine engine being linked to the pivoting plate.

### BRIEF DESCRIPTION OF THE DRAWINGS

The foregoing and other objects, features, and advantages of the present invention will be discussed in detail in the following non-limiting description of specific embodiments in connection with the accompanying drawings:

FIG. 1 shows an example of a single-column turbine engine capable of being submerged according to an embodiment of the present invention;

FIG. 2 shows the turbine engine of FIG. 1 where the base is in extended position;

FIG. 3 shows an example of a twin-column cross-flow turbine engine adapted to an installation according to an embodiment of the present invention; and

FIGS. 4A to 4G show steps of the submerging of a turbine engine in horizontal position according to an embodiment of the present invention.

For clarity, the same elements have been designated with the same reference numerals in the different drawings.

In the following, it will be spoken of top and bottom, or of upper and lower ends of a turbine engine, referring to the position that the turbine engine must have once installed, and this denomination will be kept even if the turbine engine is in horizontal position.

### DETAILED DESCRIPTION

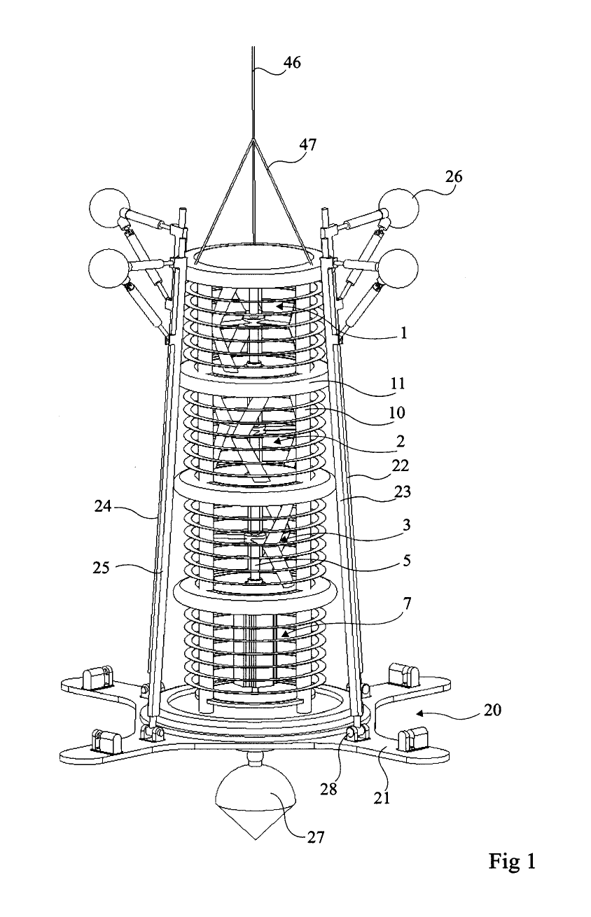

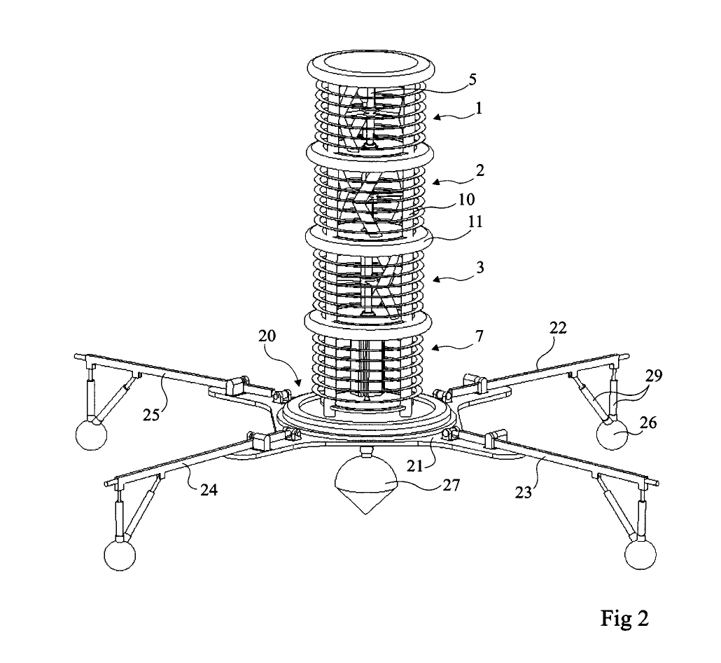

FIGS. 1 and 2 show an example of a cross-flow turbine engine adapted to a simple submerging system.

This turbine engine, of the type described in French patent No. 04/50209 (B6412—Patent 1), is associated with a holding structure of the type described in French patent application No. 05/50420 (B6869—Patent 2) and is provided with a base of the type described in undisclosed French patent application No. 08/55593 (B9030—Patent 4).

This turbine engine comprises three V-shaped wings 1, 2, and 3 attached to a same axis 5 which drives a generator 7. The assembly of the turbines and of the generator is surrounded with a holding structure comprising posts 10 connected by hoops 11 which support bearings maintaining axis 5 between two turbine engines. Preferably, the different elements of holding structure 10, 11 are solidly associated together and with a base 20 to be liftable in one block from the top, moving along the turbine engine and base 20. Base 20 comprises a base plate 21 having holding structure 10, 11 assembled thereon and having four extendable arms 22, 23, 24, 25 shown in folded position attached thereto. Substantially at the center of base plate 21, the lower end is attached to an anchoring system, for example a mooring 27, and each of arms 22 to 25 also supports a foundation system, for example, a mooring 26. Each of the arms is foldable at the level of a joint 28 to take, in the installed state, the position illustrated in FIG. 2. Each of moorings 26 is attached to its arm via a jack system 29 enabling to set its height, in order to provide the horizontality of the base plate when the machine is submerged and installed.

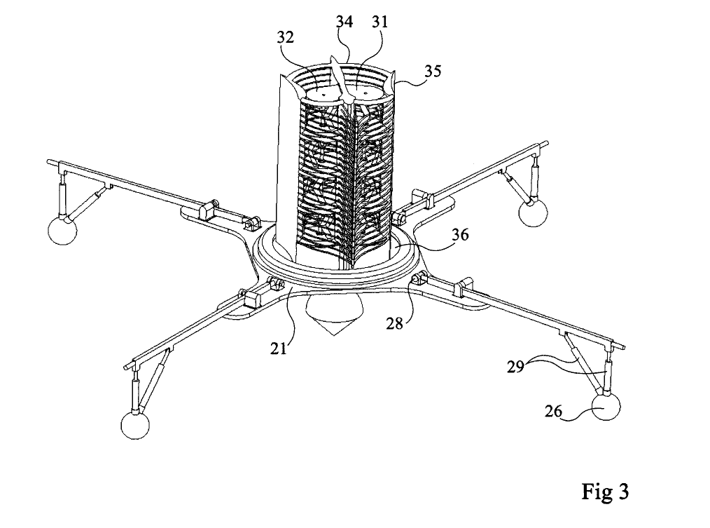

FIG. 3 shows, on a base of the same type as that illustrated in relation with FIGS. 1 and 2, a structure with twin columns 31, 32. The shaft of each of these two columns is coupled to a generator. The generator outputs are electrically added, or the two shafts are coupled to the shaft of a common generator that they contribute to drive.

The twin columns are assembled within a holding structure 34 comprising portions 35 forming a fairing, so that the structure automatically orients in the flow direction, given that the assembly of the two columns and of the fairing is connected to a plate 36 assembled to axially rotate on base plate 21.

The turbine engine structures illustrated in FIGS. 1 to 3 are examples only of structures selected herein to be submerged in a particularly simple manner. The selected structures have common features:
they have a general elongated shape, their height being equal to at least twice their diameter (this is a difference with many current turbine engines, for example, cross-flow engines, which are often wider than they are high);
they are cross-flow devices, whereby, once they have been installed, they can operate optimally whatever the flow direction (this is clear for the single-column turbine engine of FIG. 1; the same feature is obtained for the turbine engine of FIG. 3 given that, due to its fairing 35 and to its pivotal assembly on a base plate, it auto-orients in the optimal direction according to the flow)—it should be noted that single-column turbine engines with a fairing capable of being oriented to increase their efficiency may also be used;
they may comprise a base having a diameter which is not too large as compared with the average diameter of the actual turbine engine portion (this diameter may be decreased, either because, as in the shown examples, the base may take a folded position or because, basically, this base has a limited diameter, which may be possible due to its large weight, or to the selection of particularly well chosen systems to provide the turbine engine anchoring—for example, suction anchors;
there exists, on the high end of the turbine engine, at least one element rigidly connected to the low end so that this turbine engine can be lifted from the high end (in the case of FIG. 1, the hooking structure may be linked to the upper portion of holding structure 10, 11);
these are large structures of significant weight (as an example, in the case of the embodiment of FIG. 1, each turbine element may have a height ranging from 2 to 5 meters, and the holding structure may comprise hoops 11, also having a diameter ranging between 2 and 5 meters; in the case where these values are rather close to 5 meters, a total height on the order of 20 meters is obtained for an assembly with three turbine elements and one generator. The base structure will then have a diameter approximately ranging from 8 to 10 meters, the legs having, like the column as a whole, a height on the order of 20 meters; the central mooring may have a weight approximately ranging from 10 to 100 tons, for example, 50 tons, and each of the lateral moorings placed at the end of arms 22 to 25 may have a weight of several tons, for example, from 2 to 10 tons; thus, currently, the structure as a whole will have a weight ranging between 150 and 500 tons).

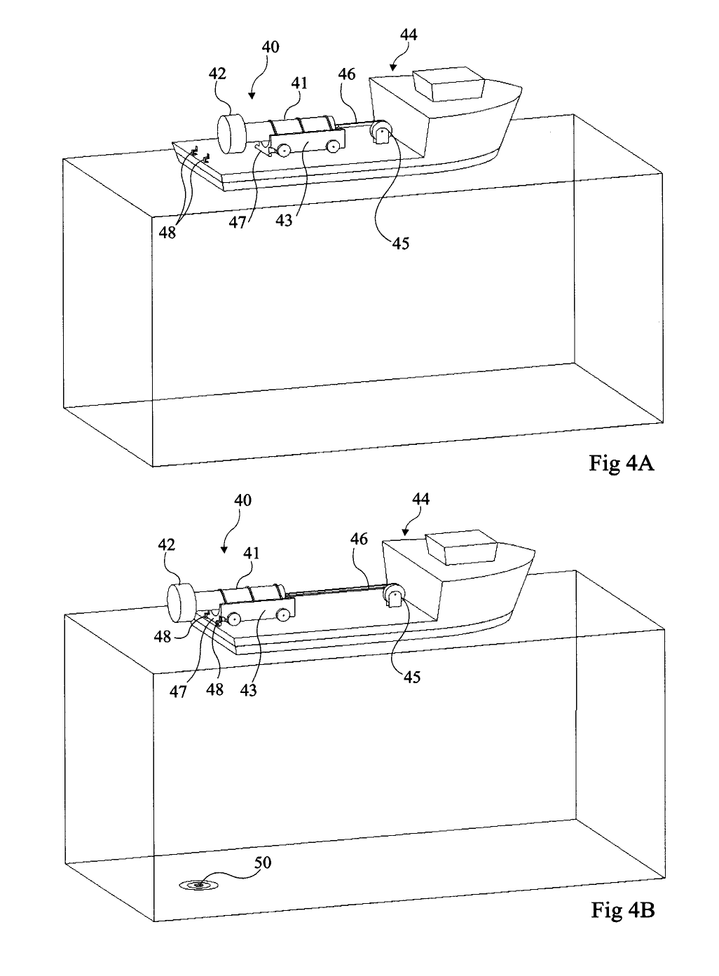

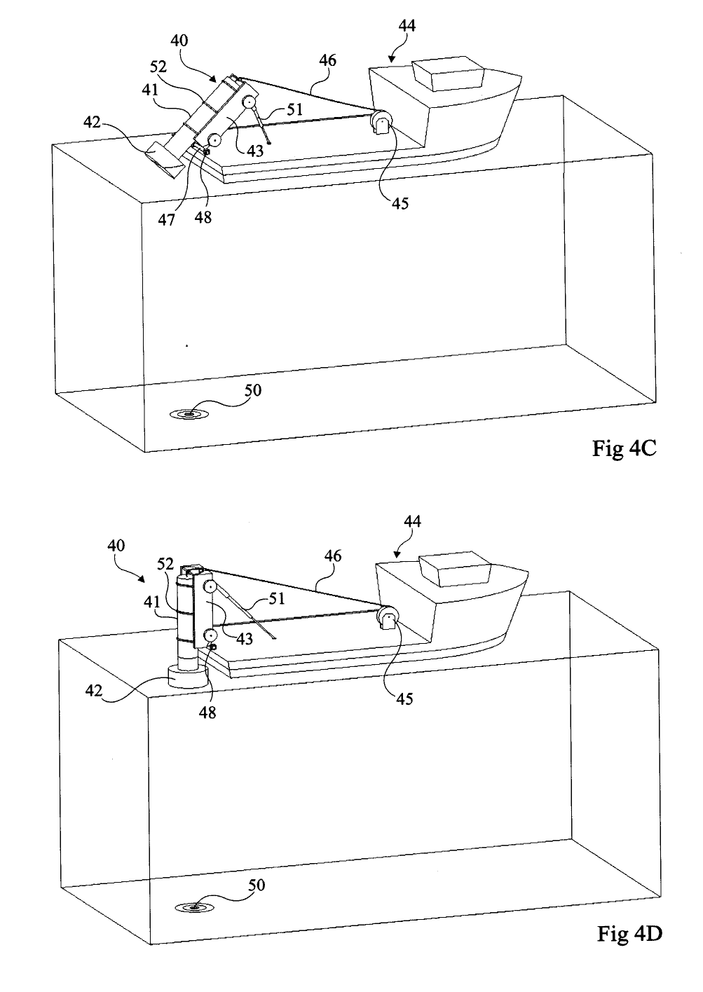

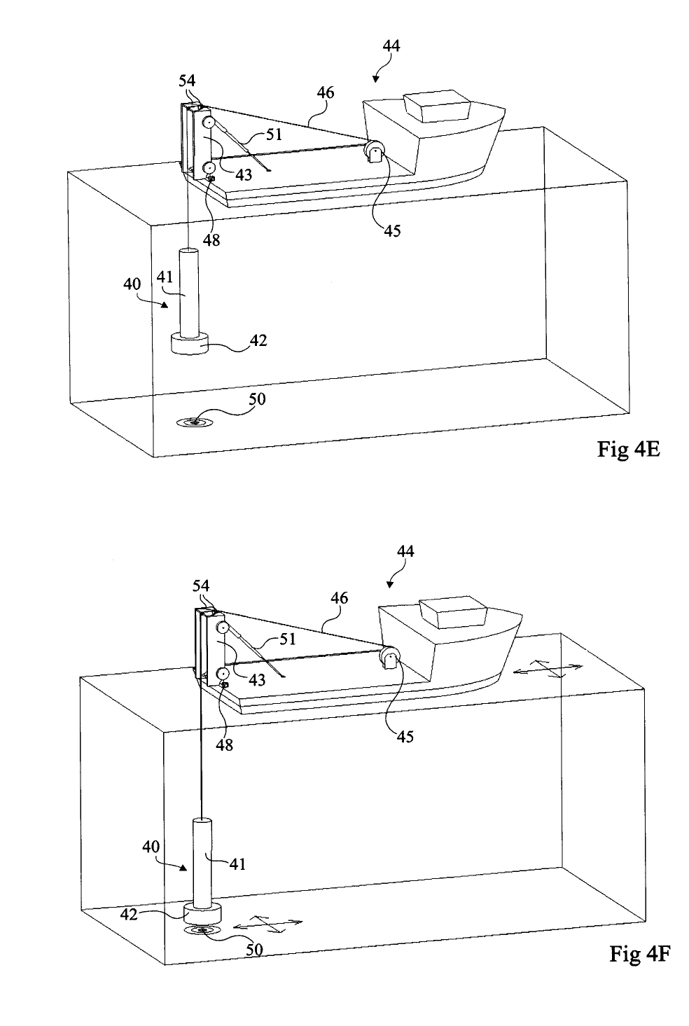

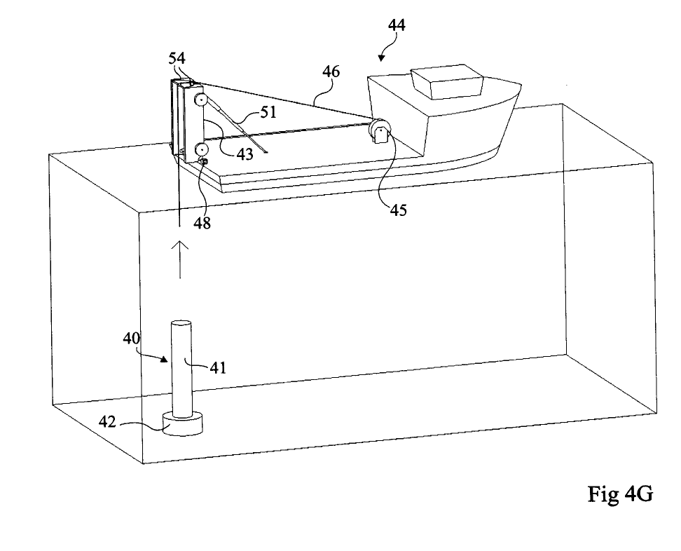

A way to install or submerge a turbine engine will now be described in relation with FIGS. 4A to 4G, keeping in mind the fact that this turbine engine corresponds to the above definitions.

FIG. 4A shows an elongated cross-flow turbine engine 40, comprising a turbine column 41 and a base structure 42. Base structure 42 preferably comprises, as indicated previously, a base plate and extendable arms, not shown. The turbine engine is laid on a carriage 43 arranged on the deck of a ship 44. It should be noted that ships 44 comprising a clear deck over a length ranging from 25 to 50 meters are current. These may be conventional ships known as “offshore support vessels” which have been designed and manufactured for offshore exploration (towing, supply, anchor upheaving, etc.). As will be seen, such ships do not have to be equipped with cranes and may have limited dimensions.

The ship deck is equipped with a winch 45 having its pull line 46 attached to the high portion of the turbine engine. Pull line 46 is also shown in FIG. 1 and its connection to the high portion of the turbine engine is performed by any known means. For example, pull line 46 is attached to several pieces of pull line 47, each of which is attached to a portion of the high portion. The attachment may for example be provided by electromagnets and is then simply removable. Although this has not been shown, in addition to pull line 46, electric cables are provided to ensure any function useful to the installation. These electric cables are used to power the attachment electromagnets which have just been mentioned. They are also used to power various jacks or electromagnets necessary to the system installation. One may also provide jacks, not shown, to lower arms 22 to 25, electromagnets to block these arms in extended position, and jacks 29 which are used to set the height of each of the arms once the arms have extended, to provide the horizontality of the installed structure. Electric connections to various sensors, for example, horizontality detection sensors, and sensors or emitters for determining the position must also be provided.

According to an important advantage of the present invention, the installation of the turbine engine on the carriage may be performed while the carriage is on shore, for example, in a shed provided with a bridge crane. Then only is the carriage supporting the turbine engine brought onto the ship deck. Although this has not been shown, it should be clear that various means for securing and protecting the carriage and the turbine engine on the ship deck may be provided.

FIG. 4B shows the carriage bearing against tilting stops 48. The rear portion of the carriage is provided with means 47, for example, hubs, capable of cooperating with the tilting stops 48 arranged on the ship stern side. At the bottom level, location 50 where the turbine engine is desired to be installed has also been shown.

As illustrated in FIG. 4C, the carriage, bearing against stops 48, is placed upright by the use of one or several jacks 51 solidly attached to the carriage or to the ship deck. During this raising operation, turbine engine 40 is held on the carriage by pull line 46 and also, preferably, by removable fasteners 52.

FIG. 4D illustrates the end of the raising step, where the machine is substantially vertical, and still maintained by fasteners 52 and pull line 46.

The beginning of the descent of the turbine engine is illustrated in FIG. 4E. A block system 54 attached to carriage 43 guides the pull line during the descent.

At the step illustrated in FIG. 4F, the turbine engine is placed in position above target location 50 and various installation operations, for example comprising the extension and the blocking of the arms, are carried out.

At the step illustrated in FIG. 4G, the turbine engine is in contact with the bottom and various installation operations are performed, for example including the horizontality setting. The turbine engine is then released from its installation pull line.

Ship 44 is provided with a dynamic positioning system, for example, of GPS type, currently equipping many offshore support vessels, to make sure that turbine engine 40 is well positioned above target 50 and the rest during its descent. Such computer-controlled dynamic positioning systems enable to maintain the ship position by using the helixes and bow thrusters of the ship. Various embarked sensors are used to provide the computer with data relative to the ship position and to the direction of the environmental forces affecting this position. Such systems are currently sufficiently accurate to enable to also consider, if the turbine engine is desired to be pulled back up, to run down a pull line and to position it properly to catch a hooking system such as a ring arranged at the top of the turbine engine.

According to a significant advantage, given that the method and the system according to the present invention apply to cross-flow turbine engines, the rotational position with respect to a vertical axis is of no importance, be it in the case of a single-column turbine engine or in the case of a twin-column turbine engine provided with a swiveling fairing and pivotally assembled around a vertical axis.

According to an advantage of the present invention, the use of cranes and other lifting elements on the ship is avoided. Only a winch of adapted power, possibly associated with various gear systems, is used.

Specific embodiments of the submerging system and of turbine engines selected for such an installation have been described previously. Of course, the present invention is likely to have many alterations and modifications which will occur to those skilled in the art, some being mentioned hereafter.

Although a ship capable of submerging one turbine engine at a time has been described, larger ships, capable of storing several turbine engines and of successively submerging them may be selected, although this is not preferred. The submerging may also be provided to be performed from any side of the ship instead of from the ship stern, by satisfactorily solving balance and heel issues.

Although a carriage provided with wheels has been described, it should be noted that, although this is preferred for the transfer of the carriage from a shed to the ship, this carriage may also be provided with other means of cooperation with the ship once it is mounted thereon, for example, rails or slide bars.

FIG. 4A shows the carriage once on the ship and FIG. 4B shows the carriage in tilting position. It should be noted that, if the base has too large dimensions, especially in the case of a fixed (non-extendable) base, the carriage may be permanently positioned in rear position such as in FIG. 4B, so that the base may protrude downwards with respect to the ship deck plane. Ships with a portal at the back of the deck may also be used to ease tilting operations.

Further, bases solidly attached to moorings (of gravity type) have been illustrated previously. Suction anchors may also be provided. Suction anchors are hollow, and have a cylindrical or trihedral shape. They are driven into the ground by pumping of the water inside of them. Such anchors may have a height ranging from up to 10 to 25 m with a diameter ranging from 3 to 7 m. The ground of the site where they must be installed (sands, clays) must have specific geomechanical features. A pneumatic line connected to a pump on the ship must then be added to the pull line and to the electric cables used to install the turbine engine. It may also be provided for the support base plate of the turbine engine to be an anchored base plate.

A preferred embodiment where an elongated turbine engine is associated with a base system to which it is solidly attached during the installation has been described. Elongated turbine engines integrating no base structure, and designed to be able to attach to a foundation system previously installed on the sea or river bed, may also be provided.

1. A method for submerging a hydraulic turbine engine comprising the steps of:
providing an assembly comprising a cross-flow turbine engine of elongated shape;
laying down said assembly on a carriage;
arranging the carriage on the deck of a ship, the lower end of the turbine engine facing the stern of the ship, the upper end being attached by a pull line to a winch secured to the ship;
placing the carriage and said assembly in upright position above the stern of the ship;
separating said assembly from the carriage; and
lowering said assembly towards the bottom while holding it by means of said pull line.

2. The method of claim 1, wherein said assembly comprises a base structure solidly attached to the lower end of the turbine engine.

3. The method of claim 1, wherein, the step where the carriage is placed upright, the turbine engine is attached to the carriage by removable fasteners.

4. The method of claim 2, wherein the base structure comprises extendable arms, and the method further comprises, once the turbine engine has been lowered all the way down to the bottom, the steps of:
extending the arms; and
setting the heights of their support points on the bottom.

5. A system for submerging a hydraulic turbine engine comprising:
an assembly comprising a cross-flow turbine engine of elongated shape;
a carriage capable of receiving said assembly in lying position;
a ship provided with a winch capable of supporting the carriage on its deck, the lower side of the turbine engine facing the stern of the ship, the upper side being linked by a pull line to the winch; and
jacks for placing the carriage and said assembly in upright position above the stern.

6. The submerging system of claim 5, wherein said assembly comprises a base structure solidly attached to the lower end of the turbine engine.

7. The submerging system of claim 6, wherein the ship is provided with a dynamic positioning system, and transmit means are connected to the bottom of the turbine engine or to the base structure.

8. The system of claim 6, wherein the base structure comprises a base plate having extendable arms solidly attached thereto, each arm being associated with one or several jacks to extend and be set, the turbine engine being connected to the ship during its positioning by electric cables capable of driving the various jacks.

9. The system of claim 5, wherein the pull line is connected to the top of a structure for holding the turbine engine.

10. The system of claim 5, wherein the pull line is connected to the turbine engine via electromagnets.

11. The system of claim 5, wherein the base structure comprises a base plate on which is assembled a plate pivoting around a vertical axis, the turbine engine being linked to the pivoting plate.
